(19) United States
(12) Patent Application Publication
(10) Pub. No.: US 2018/0233845 A1
(43) Pub. Date: Aug. 16, 2018

(54) Method and system for showing messages on a data cable

(71) Applicant: Joe Zheng, Cupertino (CA)

(72) Inventors: Haifeng Chen, Hayward, CA (US); Joe Zheng, Cupertino, CA (US)

(21) Appl. No.: 15/953,474

(22) Filed: Apr. 15, 2018

Related U.S. Application Data
(63) Continuation-in-part of application No. 15/352,523, filed on Nov. 15, 2016.
Application No. 15/352,523 is a continuation of application No. 62/385,255, filed on Sep. 9, 2016.

(51) Int. Cl. H01R 13/46; H01R 9/26; G06K 19/06; G06Q 30/02

(52) U.S. Cl. CPC H01R 13/465; H01R 9/2683; G06K 19/06121; G06Q 30/0246; G06K 19/06037; G06K 19/06178

(57) ABSTRACT

Techniques for utilizing an unused space on a connector are disclosed, where the connector is commonly seen in a multi-wire cable. The connector itself includes at least one major surface. The surface includes a message, wherein the message gets gazed at by a user when the user slides the connector into a socket of a device. The message becomes invisible after the connector is fully positioned or inserted in the socket. A counter is provided to record a number of times the connector has been used in the socket. The counter may be used by a party to allocate a set of advertisements for the user in accordance with a profile thereof or as the number of times the message has been gazed by the user.

### CROSS REFERENCE TO RELATED APPLICATIONS

This application is a continuation-in-part (CIP) of co-pending U.S. application Ser. No. 15/352,523, filed on Nov. 15, 2016.

### BACKGROUND OF THE INVENTION

### Field of the Invention

The present invention is generally related to the area of advertising on a connector, where the connector is part of a cable being portable and often used to charge or synch a mobile device with a computer (e.g., a desktop or laptop computer).

### Description of the Related Art

A mobile device is a small computing device, typically small enough to be handheld. In general, a mobile device includes a display screen and an interface (e.g., a displayed keyboard, a microphone and a camera). Most handheld devices are also equipped with Wi-Fi, Bluetooth, near field communication (NFC) capabilities and Global Positioning System (GPS). They may allow connections to the Internet and other devices, such as an automobile or a microphone headset or can be used to provide location-based services. Also typically found on these devices are the ability to take snapshots and play digital video or audio, along with a battery power source such as a lithium battery. Increasingly mobile devices also contain sensors like accelerometers, compasses, magnetometers, or gyroscopes, allowing detection of orientation and motion. Mobile devices may provide biometric user authentication, such as using the built-in camera for face recognition or using a fingerprint sensor for fingerprint recognition.

Being portable, these mobile devices have to operate on batteries. As a result, these batteries need to be recharged from time to time. Many mobile devices are provided with a charging cable that is also referred to as a data cable since the cable itself has been expanded to provide data functions as well. For example, Apple provides what is currently called Lightning to USB Cable that allows a user to connect iPhone, iPad, or iPod to a computer's USB port for syncing and charging or a USB power adapter for convenient charging from a wall outlet. Samsung and many Android-based devices manufacturers also provide what is called MicroUSB cable for the similar purposes.

One of the common features in these charging cables is the use of a connector to be inserted into a mobile device when the mobile device is ready for syncing or charging. The connector is manually inserted into a socket of the mobile device. While inserting the connector into the socket, a user must gaze at the connector for a moment. Thus there is a need to provide certain information on the connector that enjoys the look from the user almost every day.

When the information on the connector is steady, it becomes decorative and draws less attention from the user over the time. Thus there is another need for making the information dynamic so that the user would present the information or connector to see how the information has been updated or modified from time to time.

In general, it is difficult to determine how many times in a period of time a user may have gazed at a message disposed on a connector. Thus there is still another need for a mechanism capable of detecting how many times the user may have gazed at the message disposed on a connector.

### SUMMARY OF THE INVENTION

This section is for the purpose of summarizing some aspects of the present invention and to briefly introduce some preferred embodiments. Simplifications or omissions may be made to avoid obscuring the purpose of the section. Such simplifications or omissions are not intended to limit the scope of the present invention.

In general, the present invention is related to the use of an unused space of a connector commonly seen in a multi-wire cable. Such a cable is often used for charging a mobile device or data synching between two devices. According to one aspect of the present invention, a data cable is a multi-wire cable including a connector coupled at an end of the multi-wire cable. The connector itself includes a substrate with at least two major surfaces, each having a first portion and a second portion. The first portion is typically used to dispose or accommodate an array of conductors. The second portion is used to include a message, wherein the message gets gazed at by a user when the user slides the connector into a socket of a device. The message becomes invisible after the connector is fully positioned or inserted in the socket. Depending on implementation of the connector, the ratio of the first and second portions can vary considerably. In some exemplary connectors such as USB Type-C, the first portion is vanished, the array of conductors is folded or disposed onto the walls of a socket between the two major surfaces.

According to another aspect of the present invention, the message may be a plain text legible visually to a user. According to still another aspect of the present invention, the message may be a machine readable symbol illegible visually to a user. Depending on what is being encoded in the machine readable symbol, the stationary message can be made dynamic via the use of the machine readable symbol as a display linked by the content encoded in the machine readable symbol can be modified whenever there is a need.

According to yet another aspect of the present invention, a module is specifically designed to count a number every time a connector is plugged or inserted into the socket. The number may be referenced as a count a user has gazed at the message on the connector in a period. Depending on implementation, the number may be used to update a profile of the user, where the profile may be cached locally or stored in a designated server. Based on the profile, a designated server may be programmed to allocate a set of messages (e.g., advertisements) specifically for the user. The messages are displayed to the user at a predefined moment.

The present invention may be implemented as an apparatus, a method or part of a system. According to one embodiment, the present invention is a system for acknowledging a connector inserted into a socket, the system comprises a computing device, including a memory space for storing a module, equipped with the socket, wherein the socket is driven by an interface circuit therein, the circuit produces an acknowledgement signal when receiving the connector therein, the connector is coupled at an end of a multi-wire cable and includes at least one substrate having a message thereon, wherein the message gets gazed at by a user when the user slides the connector into the socket, the message becomes invisible after the connector is properly positioned in the socket and causes the module to be executed by a processor in the mobile device.

According to another embodiment, the present invention is a method for acknowledging a connector inserted into a socket, the method comprises providing a multi-wire cable with the connector, wherein the connector includes at least one substrate having a message thereon, the message gets gazed at by a user every time the user slides the connector into the socket, and wherein the socket is enclosed in a mobile device, the message becomes invisible after the connector is fully positioned in the socket. The method further comprises executing a module installed in the mobile device to be executed, the module maintaining a counter that increments every time the connector is received in the socket; and transporting the counter to a designated server to update a profile of the user.

One of the objects, features, and advantages of the present invention is to take advantage of the unused or available space on the surface of a connector for a special message, where the special message gets looked at almost every day.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings where:

FIG. 1A shows a photo of Lightning to USB Cable being promoted and provided by Apple Inc. (a.k.a., Apple);

FIG. 1B shows separate blocks respectively corresponding to certain parts of an exemplary cable similar to Lightning to USB Cable;

FIG. 1C shows a set of samples that may also be embedded on a connector, where the samples include a symbol or a combination of a symbol and a logo;

FIG. 1D shows an example of two USB Type-C connectors;

FIG. 1E shows a cross-section of the exemplary USB Type-C connector example of two USB Type-C connector shown in FIG. 1D;

FIG. 1F shows an illustration of such a connector used for carrying a specific message (e.g., a logo);

FIG. 2A shows an example of disposing a message on a connector being manufactured;

FIG. 2B shows an example of making a shell used for the connector, where two sides of the shell may be used for imprinting a message;

FIG. 3A shows a flowchart or process of manufacturing a connector for a cable;

FIG. 3B shows a flowchart or process of decoding a machine readable symbol imprinted on a connector

FIG. 4A shows an example of a connector with an exemplary imprinted logo, where the connector is being inserted into a socket and triggers the interface in the socket;

FIG. 4B shows a functional diagram of a mobile device implemented with a counter to count how many times a socket receives a plug or connector during a predefined period;

FIG. 5A shows a flowchart or process of counting an event in which a plug is received in a socket of a mobile device, where a counter may be used to update a local profile of the user or a mater profile of the user in a designated server; and

FIG. 5B shows an exemplary display to show an updated counter recording an event that a connector has been inserted into a socket.

### DETAILED DESCRIPTION OF THE PREFERRED EMBODIMENTS

The detailed description of the present invention is presented largely in terms of procedures, steps, logic blocks, processing, or other symbolic representations that directly or indirectly resemble the operations of data processing devices. These descriptions and representations are typically used by those skilled in the art to most effectively convey the substance of their work to others skilled in the art. Numerous specific details are set forth in order to provide a thorough understanding of the present invention. However, it will become obvious to those skilled in the art that the present invention may be practiced without these specific details. In other instances, well known methods, procedures, components, and circuitry have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments.

The present invention pertains to a system, a method, a platform and an application each of which is invented, uniquely designed, implemented or configured to use an available area in a connector to convey information to a user of the connector. As used herein, any pronoun references to gender (e.g., he, him, she, her, etc.) are meant to be gender-neutral. Unless otherwise explicitly stated, the use of the pronoun “he”, “his” or “him” hereinafter is only for administrative clarity and convenience. Additionally, any use of the singular or to the plural shall also be construed to refer to the plural or to the singular, respectively, as warranted by the context.

One of the benefits, advantages and objectives in one embodiment of the present invention is to utilize an available area on a connector for a message disposed thereon, wherein the message is generally static but can be made dynamic via a machine-readable symbol according to one embodiment. To facilitate the description of the present invention, a message or an advertisement (ad) are interchangeably used herein. Those skilled in the art well understand that a message can be in any form (such as a text, a graph, a photo, and a machine-readable symbol) and does not have to be an advertisement.

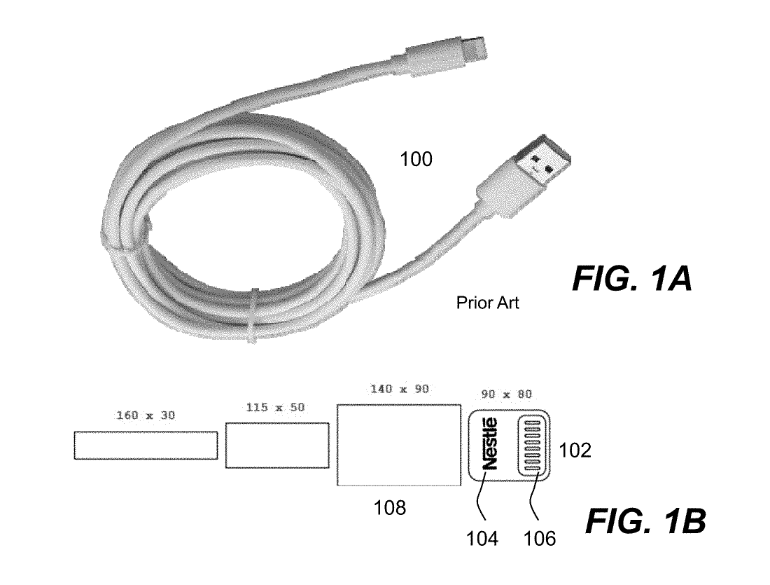

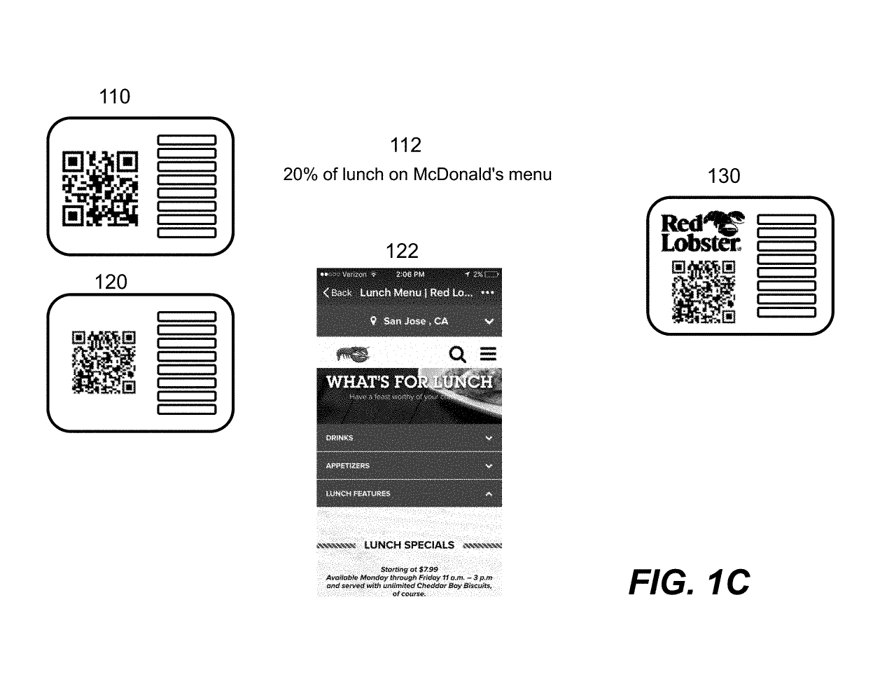

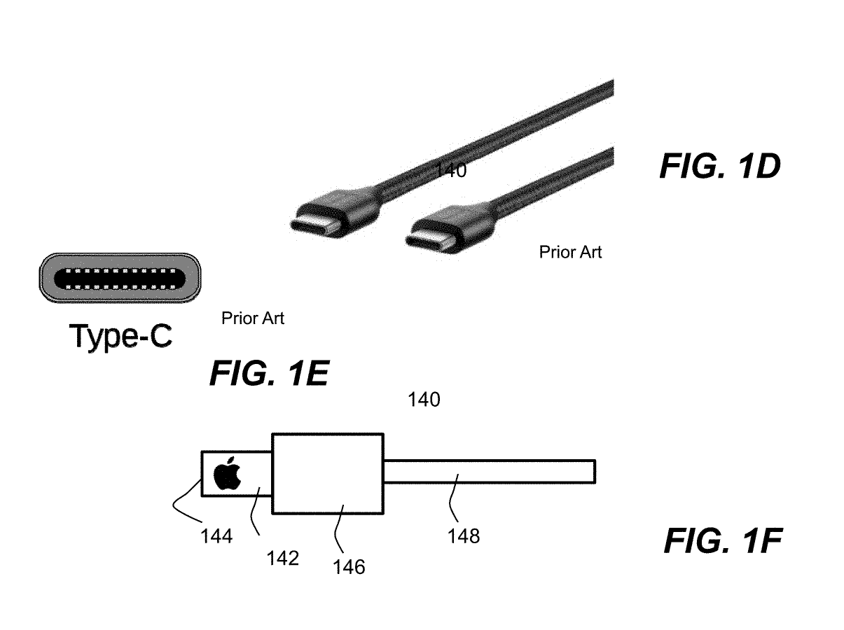

Referring now to the drawings, in which like numerals refer to like parts throughout the several views. FIG. 1A shows a photo of Lightning to USB Cable 100 promoted and provided by Apple. The cable 100 is a proprietary computer bus and power connector created by Apple Inc. Introduced on Sep. 12, 2012 to replace its predecessor, a 30-pin dock connector. The cable 100 is used to connect Apple mobile devices like iPhones, iPads and iPods to host computers, external monitors, cameras, USB battery chargers and other peripherals. Using 8 pins instead of 30 on a connector 102, on the cable, shown in FIG. 1B, the cable 100 is significantly more compact than the 30-pin dock connector and can be inserted with either side facing up.

FIG. 1B shows separate blocks respectively corresponding to certain parts of an exemplary cable similar to Lightning to USB Cable 100. It should be noted that Lightning to USB Cable from Apple is used to facilitate the description of this invention. Those skilled in the art shall appreciate that the description herein is equally applicable to other types of cable for the similar purposes (e.g., connecting a mobile device to another device). The connector 102 is the part to be inserted into a socket, where the socket is often placed pr provided somewhere around the edge of a mobile device. When a user needs to charge or data synch a mobile device, he has to gaze at the connector 102 while guiding the connector 102 into the socket.

According to one embodiment, one side of the connector 102 includes a message 104 that may be a static sign or a logo. One of the advantages, benefits and objectives in the present invention is to dispose a message that has to be viewed every time a user needs to use a charging or data cable. As shown in FIG. 1B, the message is imprinted or printed on an available space right above or next to the conductor strips 106. Once the connector 102 is inserted or accommodated fully in a socket, the message itself is no longer visible.

Another one of the benefits, advantages and objectives in one embodiment of the present invention is to conceal the message on a connector of a cable once the cable is placed in operation. In other words, the user is not obligated to gaze at the message for too long. As a result, the cable looks no different from other cables in operation. In practice, a cable contemplated in the present invention looks quite similar to other cables of the same type, the difference gets only noticed when a user uses it for connection.

As shown in FIG. 1B, the message 104 is a company logo. A logo is a graphic mark, emblem, or symbol commonly used by commercial enterprises, organizations and even individuals to aid and promote instant public recognition. FIG. 1C shows samples that may also be printed in dark ink on a connector, where the samples include a symbol or a combination of a symbol and a logo. A connector 110 is shown to have a QR code (abbreviated from Quick Response Code). A QR code is a type of barcode or two-dimensional barcode. A barcode is a machine-readable optical label that contains information about the item to which it is attached. A QR code uses four standardized encoding modes (numeric, alphanumeric, byte/binary, and kanji) to efficiently store data. Although a user would not be able to tell what is in the QR code, most of the mobile devices are equipped with a reader or loaded with an App to read out such a barcode (hence machine readable code). The illegibility of the code often causes a curious user to use a handy reader to read out the code. If the content from the code is usable, there is a high possibility that the user may very well use or redeem it when there is an opportunity. The corresponding content 112 is shown next to the code 110. If it is near lunch time, the user may bring the cable with him to a nearby McDonald to take the advantage of the discount in the code embedded or imprinted on the connector.

A connector 120 is shown to include another QR code. Once the QR code is read or decoded, a display 122 is caused to display the lunch special at Red Lobster in a city near the user. It should be noted that the location information is not needed to be coded in the symbol. In one embodiment, when the symbol is read out, a corresponding App can be designed to call on the GPS function in a mobile device to determine where the user is at the moment and look for an appropriate store corresponding to the location of the user, and subsequently display a corresponding lunch special from the store. FIG. 1C also shows a combination of a logo and a symbol.

FIG. 1D shows an example of a set of USB Type-C connectors. In one example, each of the Type-C connectors is at one end of a cable (e.g., a data/charging cable). In another example, one of the Type-C connectors is used for one end of a cable, presumably, another end of the cable may use a different type of connector. USB Type-C or simply USB-C is an emerging industry-standard connector for transmitting both data and power. The USB-C connector was developed by the USB Implementers Forum, the group of companies that has developed, certified, and shepherded the USB standard. It counts more than 700 companies in its membership, including Apple, Dell, HP, Intel, Microsoft, and Samsung.

In any case, the Type-C connector has a slightly different structure than the one shown in FIG. 1A or 1B. FIG. 1E shows a cross-section of the exemplary USB Type-C connector. Instead of two different portions on a surface of the connector shown in FIG. 1A or 1B, there is only one portion on the surface of the USB-C connector. In other words, the conductor strips 106 of FIG. 1B seem to be folded into or hidden in a socket sandwiched by or between two parallel surfaces as shown in FIG. 1E. Regardless of whatever the internal structure could be in the connector, the USB-C connector presents at least two areas for carrying a message.

FIG. 1F shows a line drawing in which an exemplary USB-C connector 140 has at least one metal surface portion 142. The metals or conductor strips 144 are hidden in the socket as illustrated in FIG. 1E. A holding portion 146 is where a user may hold to insert or unplug the connector 140 into or from a socket located in another device (e.g., a laptop computer). As shown in FIG. 1F, a logo is imprinted on one side of the connector 140. It can be appreciated that a user will have to gaze at the logo when using the cable to charge the battery of a mobile device or synch the mobile device with a computer. Such a logo would become invisible when the connector 140 is fully inserted or plugged into a socket, thus causing no distraction from a user.

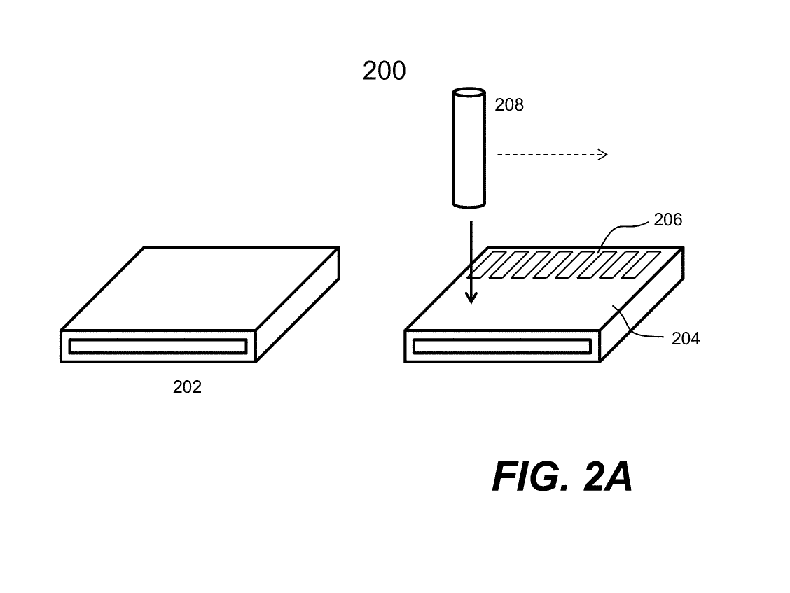

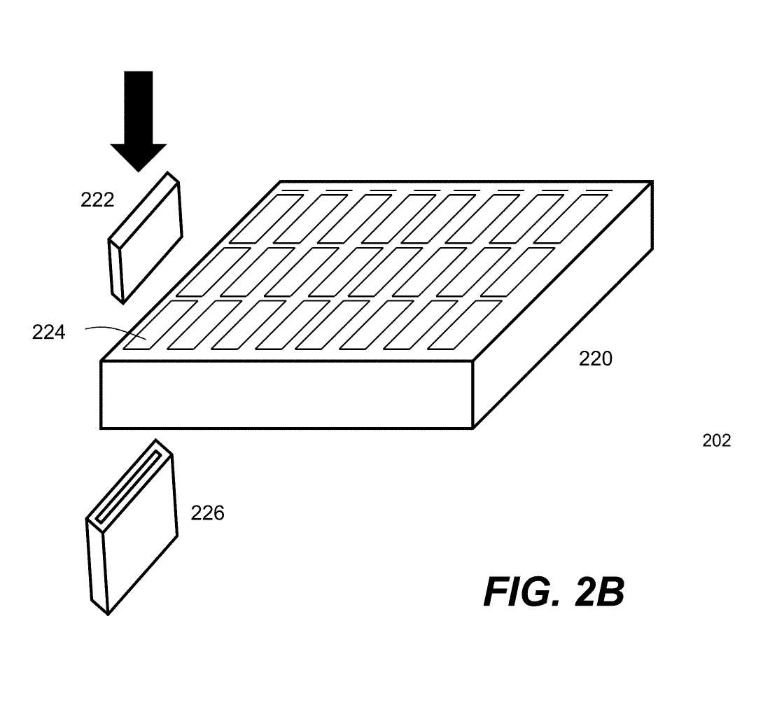

Referring now to FIG. 2A, it shows an example 200 of disposing or making a message on a connector being manufactured. According to one embodiment, a flat substrate (e.g., plastic or metal) is cut into a segment on which the conductor strips may be formed. Either or both sides of the substrate may be used to have the message imprinted thereon. According to another embodiment, a metal case 202 is molded or compressed from a metal sheet depending on a process being used. Once the metal case 202 is done, a process is employed to dispose a message in an available space 204 of the connector (e.g., USB-C) or over the conductor strips 206. Depending on the nature of the message, various methods may be used. For example, if the message is a logo, the logo may be embodied, imprinted or printed in a color in the available space 204. If the message is a barcode (e.g., a QR code) that is ideally presented in black and white or dark color, such a barcode is typically printed in a special ink in the available space 204. As shown in FIG. 2A, a header 208 is caused to move across the space 204 to dispose a message (e.g., print a barcode in ink or embody a logo). It can be appreciated that both sides of a conductor can carry the same message or different messages.

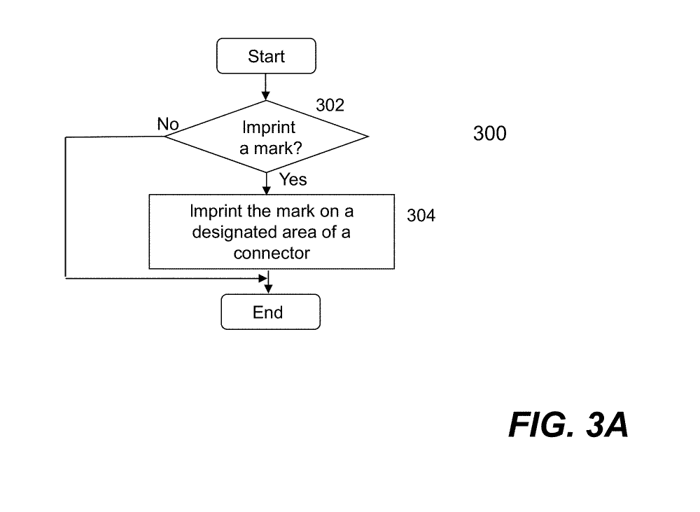

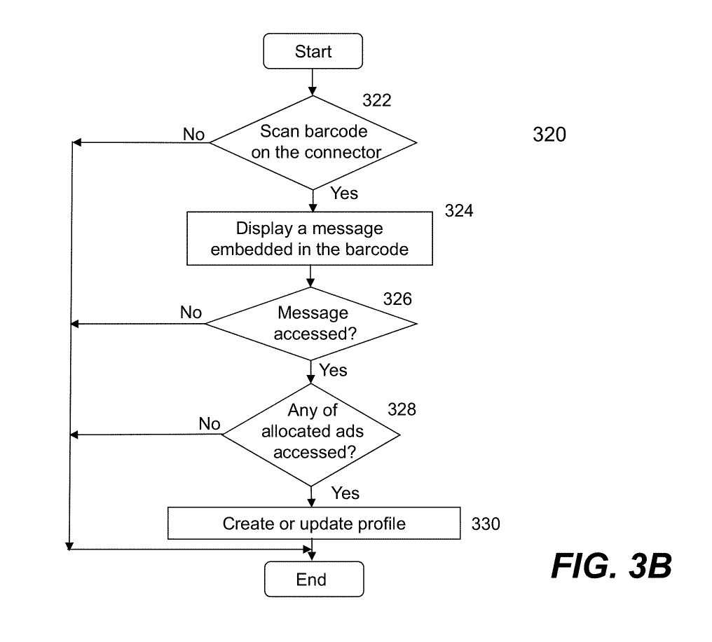

FIG. 3A shows a flowchart or process 300 of manufacturing a connector for a cable. The process 300 is started when a substrate is made out of certain material (e.g., metal or plastic). According to one embodiment, the substrate is a piece of segment or a hollow case 202 as shown in FIG. 2. According to one embodiment, the hollow case 202 is made out from a metal sheet (e.g., steel or aluminum). Referring back to FIG. 2B, it shows an example of how such hollow case or shell is made out of a metal sheet 220. Different from iron, the metal used to make the shells is type of alloy with certain extensible or flexible characteristics. When a specially shaped punch 222 is pressed downwards against the metal sheet 220 at a predetermined, the particular area 224 being punched is extended downwards, the shell 224 is formed after being cut from the metal sheet 220. In general, the hollow space in the shell 224 is about the size of the punch 222 while the walls of the shell 224 is formed by stretching the particular area 224 with the downward movement of the punch 222. To increase the efficiency and distribute the pressure on one spot of the metal sheet, an array of the punches is preferably used to create a set of the shells simultaneously.

Returning to FIG. 3A, with the availability of the shells, at 302, the process 300 is determined whether a message is to be disposed on the available space on the shell surface or beyond an area used for conductors or metal strips. In one case, the manufacturer of the cables or the connectors are charged to produce OEM products for a brand manufacturer, in which case the brand manufacturer may not want to have any message on the cables or the connectors, thus the process 300 ends. In another case, the manufacturer of the cables or the connectors are in the business of selling their own branded cables and can add any messages if desired.

According to one embodiment, the manufacturer of the cables or distributors thereof may want to give away the cables with a message on the connectors, where the message is supplied or requested by an advertiser. The process 300 now goes to 304 where each of the substrates is made to carry a designated message. The cost of the cables or the connectors may be subsidized by the fees charged to the advertiser for advertising on the cables or connectors thereof. In one case, a national franchise restaurant may order one million units of such cables and distribute them free to a group of people. The message on the connectors becomes visible to these people when they use the cable for charging their mobile device or data synching with another device.

When the message is a machine readable symbol, a user understands how to decode it and may bring the cable to a place to redeem a discount offered in the symbol. As a symbol can be encoded to include a link, the content of the link at a server or another computing device may be updated and modified anytime by the advertiser, resulting in the message on a connector dynamic via the use of a machine readable symbol.

Referring now to FIG. 3B, it shows a flowchart or process 320 of decoding a machine readable symbol imprinted on a connector. The process 320 starts when a user decides to find out what is in the symbol. As an example, a connector is imprinted with a QR code in dark ink. In comparison to a QR code in black and white, only the black portions of the QR code are imprinted. The light color or metal reflection serves as the white portions of the QR code as shown in FIG. 1C.

At 322, the user uses his mobile device with a camera to image the symbol on the connector, where an App (e.g., Camera in iPhone or WeChat from Tencent Technology (Shenzhen) Co Ltd. in China) decodes the symbol and extracts the content therein. The process 322 goes to 324, where the content may be displayed or a display linked by the content is displayed. According to one embodiment, a user brings a cable to a store to redeem an offer encoded in the symbol. The store may be equipped with a reader to read out the symbol and redeems the offer accordingly. At 326, depending on the nature of the content in the symbol, the user can see a simple text message or a graph in which case the process 320 ends or a display directed by the decoded link in the symbol in which case the process 320 goes to 328.

According to one embodiment, the display is a special message to the user with the cable. An advertiser controls the link in the symbol. When the symbol is decoded, the user is brought to a site to see the special message (e.g., a discount advertisement). As the site is controlled by the advertiser, the content or the advertisement at the site can be updated whenever the advertiser desires, resulting in dynamic messaging to the user via a machine readable symbol imprinted on an available space on a connector or plug.

At 330, the user may be requested to provide some information to create a profile so that the advertiser knows how to further service the user with more focused commercial information. As will be further described below, the profile can be used keep a log of using a data cable with the connector as described herein. As an example, a log may include, but not be limited to, a number, a time, a date, and/or a location. The number is a counter recording how many times the user has used the connector during a period of time (e.g., a day, a week or a year). The time/date records a specific time/data the connector has been used. As many mobile devices has the capability of detecting their own locations (e.g., via GPS), the location of where the connector was used can also be recorded in the location. Despite other parameters that may be included, the log presents how a connector has been used by the user, which may provide an advertiser or provider of the message a clear use profile of the connector.

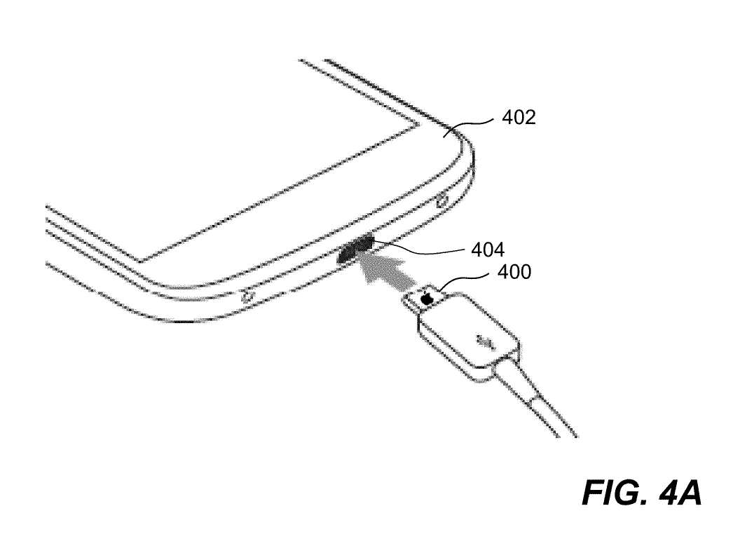

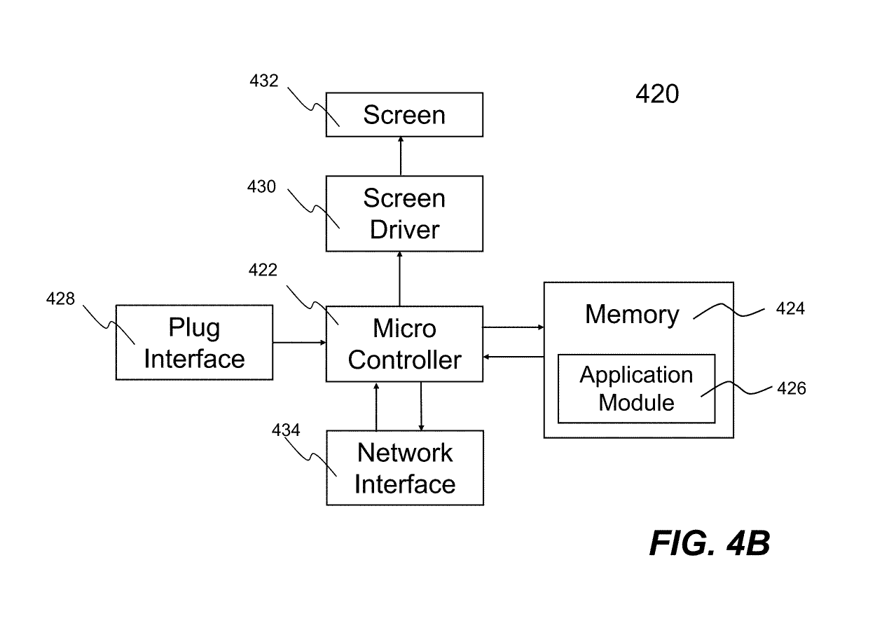

Referring now to FIG. 4A, it shows an exemplary connector 400 is being inserted into a mobile device 402 (e.g., smartphone). Specifically, there is a socket 404 on the mobile device 402. Depending on the type of connectors, there are different types of sockets. One thing in common is that there is an interface circuit in the socket that detects the presence of a connector. In other words, when the socket 404 receives the connector 400 or the connector 400 is inserted into the socket 404, the interface circuit (not shown) creates a signal indicating the connector 400 has been properly connected, charging or data synchronization may proceed.

Referring now to FIG. 4B, it illustrates an internal functional block diagram 420 of an exemplary mobile device that may be used in FIG. 4A. The mobile device 420 includes a microprocessor or microcontroller 422, a memory space 424 (e.g., RAM or flash memory) in which there is a client module 426, an input interface 428, a screen driver 430 to drive a display screen 432 and a network interface 434. The client module 426 may be implemented as an application implementing one embodiment of the present invention, and downloadable over a network from a library (e.g., Apple Store) or a designated server. The plug or input interface 428 is designed to detect the presence of a connector. Such interfaces are commonly seen in a mobile device. The details of the interface 428 is omitted herein to avoid obscuring important aspects of the present invention.

According to one embodiment, when a connector is inserted into a socket, the interface supporting or driving the socket creates a signal that is transported to the controller 422 to indicate that a charging or data synchronization procedure may be started. In the context of the present invention, the controller 422 causes the module 426 to be executed. Depending on implementation, the module 426 records the event and may feed a message (e.g., advertisement) to the screen driver 430 to display it on the screen 432 when necessary.

According to one implementation, the client module 426 is loaded in the memory 424 and executed by the controller 422 to receive or acknowledge the signal from the interface 428. As described above, for the interface 428 to create the signal, the connector must be fully inserted into the socket. As a result, the message imprinted on the socket becomes invisible. The client module 426 may then fetch an allocated advertisement to display on the screen 432, where the advertisement corresponds to the message on the connector.

The advertisement may be simply viewed, interacted with or forwarded to a contact (e.g., spouse or friend) by the user of the mobile device. Depending how the advertisement is viewed, the client module 426 reports back to a designated server, where a profile of the user is updated. In one embodiment, an account of the user is awarded with a payment for viewing an allocated advertisement as mutually agreed between the user and an advertiser via a publisher running the server.

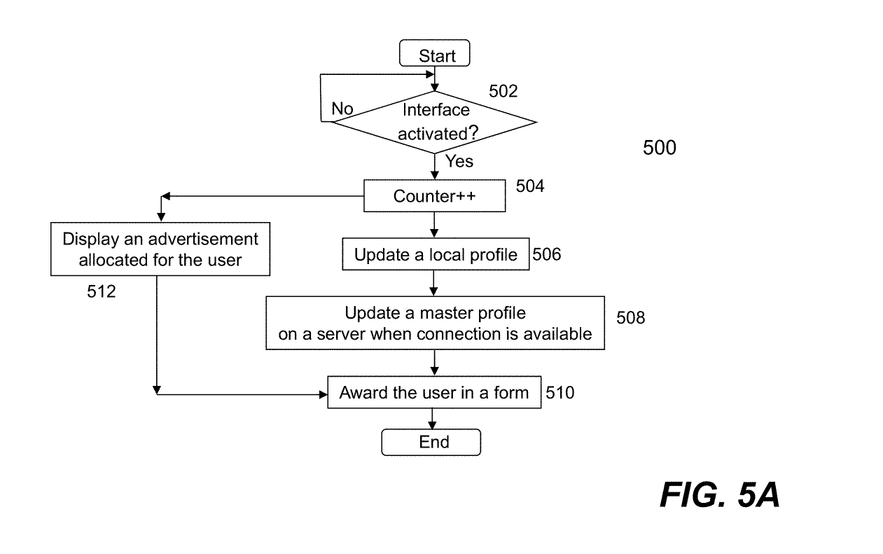

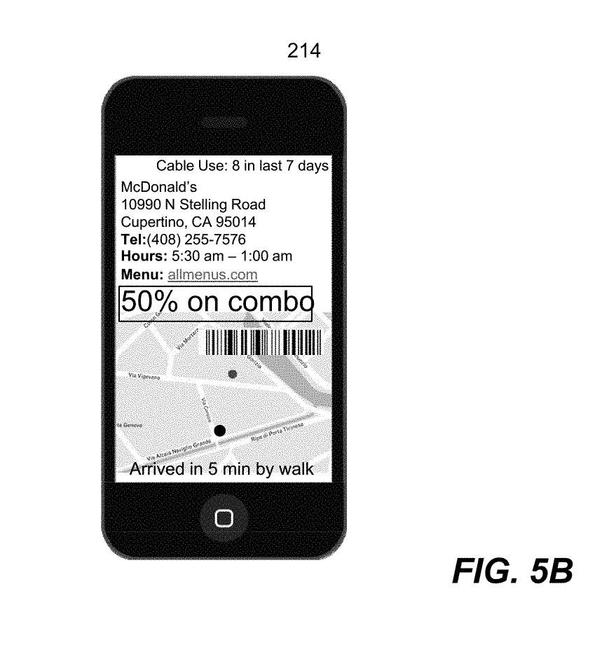

FIG. 5A shows a flowchart or process 500 counting an event when a connector is received in a socket. The process 500 may be implemented in software and hardware, and may be further understood in reference to the description above as well as the previous drawings. The process 500 starts at 502 when a connector is received in a socket in which an interface circuit is triggered. It is assumed that the connector is electrically coupled with the socket. The process 500 moves to 504 to count it as an updated event, which means the user of a data cable with the connector has gazed at the message on the connector. In other words, a counter increments by one, possibly along with the time of the day and the geographical location of the use.

At 506, a local profile is updated. In one embodiment, the mobile device is caused (e.g., by a mobile 426 of FIG. 4B) to retain a profile of the user or a log of the activities of the connector. Depending on implementation, the profile may include a nick name of the user, his interests, recent or planned purchases. These information may facilitate a publisher to allocate one or more advertisements for the user and compensate the user for viewing the advertisements.

In general, the mobile device is coupled to a network (e.g., via LTE or Wi-Fi). The profile or log may be transferred to a designated server at 5108 (e.g., operated by a publisher of the advertisements), where a master version of the profile is maintained and a copy of the profile is used by the publisher to allocate proper advertisements for the user.

At 504, when the counter increments (meaning the connector has been properly inserted into the socket), an advertisement may be called upon to be displayed on the mobile device. At the moment, the user may choose to discard the displayed advertisement or interact with it. In general, the advertisement is not randomly provided but allocated specifically for the user based on a profile created therefor. As a result, the user is awarded for viewing the advertisement at 510.

FIG. 5B shows an exemplary display 520 to show an updated counter 528. Optionally, the display 520 brings up a location of where the latest use of the connector. If needed, the user may click the counter to see the previous uses of the connector and the corresponding locations thereof. An allocated advertisement may also be provided and includes a nearby location where the advertisement may be consummated, a corresponding phone number or an electronic coupon (e.g., 1-D or 2-D barcode or symbol) that may be scanned or read when the user uses it at a checkout counter. In one embodiment, the advertisement or the coupon therein is personalized per the user so that the advertiser/publisher can be electronically notified that the ad has been utilized. In addition, the display 520 may also show an electronic map or activate a map application such as Google Map to show how far it is from where the user is now and the routing direction.

It should be noted that the description of the present invention is not limited to something that can only be viewed. Those skilled in the art can appreciate that audio content may also be provided in the context of the present invention.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiments.

We claim:

1. A system for acknowledging a connector inserted into a socket, the system comprising:
a computing device, including a memory space for storing a module, equipped with the socket, wherein the socket is driven by an interface circuit therein, the circuit produces an acknowledgement signal when receiving the connector therein, the connector is coupled at an end of a multi-wire cable and includes at least one substrate having a message thereon, wherein the message gets gazed at by a user when the user slides the connector into the socket, the message becomes invisible after the connector is properly positioned in the socket and causes the module to be executed by a processor in the mobile device.

2. The system as recited in claim 1, wherein the module maintains a counter incrementing every time the socket receives the connector.

3. The system as recited in claim 2, wherein the computing device includes a location mechanism determining a location of the computing device, the module is caused to retrieve the location every time the socket receives the connector.

4. The system as recited in claim 3, wherein the counter and the location are registered and are transported to a designated server.

5. The system as recited in claim 1, wherein the message includes a machine readable symbol.

6. The system as recited in claim 5, wherein the machine readable symbol is readable by a camera together with an application installed and executed in the computing device.

7. The system as recited in claim 6, wherein the machine readable symbol is encoded with a text message or a link.

8. The system as recited in claim 7, wherein a display is shown when the link is extracted from the machine readable symbol.

9. The system as recited in claim 8, wherein the multi-wire cable is portable and the connector thereof is presentable to a place by the user to redeem what is presented or encoded in the message.

10. The data cable as recited in claim 8, wherein the machine readable symbol is a barcode or a two-dimensional barcode.

11. The data cable as recited in claim 1, wherein the message is illegible visually to the user.

12. The system as recited in claim 11, wherein the message is stationary and made dynamic by updating or modifying a display directed by a link encoded in the message.

13. The system as recited in claim 14, wherein the data cable is a message carrier by the user to show the message in the second portion to another party.

14. The system as recited in claim 1, wherein the module causes a display to display an advertisement upon the socket receiving the connector, the user is awarded for viewing the display or interacting with the display.

15. A method for acknowledging a connector inserted into a socket, the method comprising:
providing a multi-wire cable with the connector, wherein the connector includes at least one substrate having a message thereon, the message gets gazed at by a user every time the user slides the connector into the socket, and wherein the socket is enclosed in a mobile device, the message becomes invisible after the connector is fully positioned in the socket;
executing a module installed in the mobile device to be executed, the module maintaining a counter that increments every time the connector is received in the socket; and
transporting the counter to a designated server to update a profile of the user.

16. The method as recited in claim 15, wherein the mobile device includes an interface circuit supporting the socket, the circuit generates an acknowledgement signal when the connector is fully inserted in the socket, the acknowledgement signal causes the module to executed and the counter to increment by a unit.

17. The method as recited in claim 16, further comprising:
allocating a set of advertisements for the user based on the profile thereof; and
displaying one of the advertisements when the acknowledgement signal is generated;

18. The method as recited in claim 17, further comprising:
awarding the user for viewing or interacting with the one of the advertisements.

19. The method as recited in claim 17, wherein the connector includes a shell made out of a metal sheet, the message is imprinted on one side or both sides of the shell.
